(19) United States
(12) Patent Application Publication
(10) Pub. No.: US 2012/0225359 A1
(43) Pub. Date: Sep. 6, 2012

(54) Electrolytes in Support of 5 V Li ion Chemistry

(75) Inventors: Kang Conrad Xu, North Potomac, MD (US); Arthur von Wald Cresce, Silver Spring, MD (US)

(73) Assignee: U.S. Government as represented by the Secretary of the Army, Adelphi, MD (US)

(21) Appl. No.: 13/446,061

(22) Filed: Apr. 13, 2012

Related U.S. Application Data
(63) Continuation-in-part of application No. 12/952,354, filed on Nov. 23, 2010.
(60) Provisional application No. 61/560,879, filed on Nov. 17, 2011.
(60) Provisional application No. 61/361,625, filed on Jul. 6, 2010.

(51) Int. Cl. H01M 10/056; H01G 9/035; B82Y 30/00

(52) U.S. Cl. 429/338; 429/188; 429/199; 429/200; 429/342; 429/343; 429/337; 429/341; 429/336; 429/340; 429/339; 252/62.2; 977/742

(57) ABSTRACT

This invention described the preparation of a series of compounds selected from the group comprising tris(1,1,1,3,3,3-hexafluoro-iso-propyl)phosphate, tris(perfluoroethyl)phosphate, tris(perfluoro-iso-propyl)phosphate, bis(1,1,1-trifluoroethyl)fluorophosphate, tris(1,1,1-trifluoroethyl)phosphate, hexakis(1,1,1-trifluoroethoxy)phosphazene, tris(1,1,1-trifluoroethoxy)trifluorophosphazene, hexakis(perfluoro-t-butyl)phosphazene and tris(perfluoro-t-butyl)phosphate. These compounds may be used as co-solvents, solutes or additives in non-aqueous electrolytes in various electrochemical devices. The inclusion of these compounds in electrolyte systems can enable rechargeable chemistries at high voltages that are otherwise impossible with state-of-the-art electrolyte technologies. These compounds are chosen because of their beneficial effect on the interphasial chemistries formed at high potentials, such as 5.0 V class cathodes for new Li ion chemistries. These compounds may be used in Li ion battery technology and in any electrochemical device that employs non-aqueous electrolytes for the benefit of high energy density resultant from high operating voltages.

### CROSS REFERENCE TO RELATED APPLICATIONS

This application claims benefit of Provisional U.S. Application No. 61/560,879 filed 2011-11-17 and is a continuation-in-part of Non-provisional U.S. application Ser. No. 12/952,354 filed 2010-11-23, which claims benefit of Provisional U.S. Application No. 61/361,625 filed 2010-07-06, the complete disclosures of which, in their entirety are herein incorporated by reference.

### GOVERNMENT INTEREST

The inventions herein may be made, used, sold, imported and/or licensed by or for the United States Government without payment of royalties thereon.

### BACKGROUND OF THE INVENTION

1. Field of the Invention

The present invention relates to electrolytes having a very wide electrochemical stability window, and can therefore support Li ion chemistries occurring near or above 5.0 V in electrochemical cells. More particularly, this invention relates to compounds that can be incorporated into electrolytes as co-solvents, additives, or solutes, so that the electrolytes can support the reversible Li ion intercalation/de-intercalation chemistry at potentials above 4.5 V. Still more particularly, this invention relates to compounds that can be incorporated into the electrolyte, which, upon the initial charging of the cathode, decompose sacrificially to form a passivation film on the cathode. This passivation film prevents sustaining decomposition of electrolyte components but does not hinder the reversible Li ion intercalation/de-intercalation chemistry at potentials above 4.5 V.

The invention of such an electrolyte will enable the use of high voltage cathode materials, affording new rechargeable battery chemistries with higher energy density as well as delivering energy of higher quality in the form of direct electricity current at higher voltages, which are unavailable otherwise from the state-of-the-art electrolytes. The state-of-the-art electrolytes, comprising mainly organic carbonate esters, decompose at potentials below 4.5 V on high voltage cathode surfaces and cause sustaining capacity fading accompanied with increasing cell impedances.

The high voltage cathodes include, but are not limited to, transition metal-oxides with spinel lattice structures or metal phosphates with olivine lattice structures, or metal fluorides with conversion reaction natures.

More particularly, the compounds of the present invention go beyond the battery application and could benefit any electrochemical devices that pursue higher operating potentials. The presence of the compounds in the electrolyte can stabilize the highly oxidizing surface of the positive electrode and hence enable new chemistry that is otherwise impossible with the current state-of-the-art electrolyte technology. Such electrochemical devices include, but are not limited to, rechargeable batteries, double layer capacitors, pseudo-capacitors, electrolytic cells, and fuel cells.

Still more particularly, the batteries or the electrochemical devices comprise, but are not limited to, (1) an anode such as lithium or other alkaline metals, alloys of lithium or other alkaline metals, intercalation hosts such as layered structured materials of graphitic, carbonaceous, oxides or other chemical natures, non-intercalating hosts of high surface area or high pseudo-capacitance; (2) a cathode such as an intercalation host based on metal oxides, phosphates, fluorides or other chemical natures, or non-intercalating hosts of high surface area or high pseudo-capacitance; and (3) an electrolyte of the present invention. These electrolytes comprise (a) one or more electrolyte solutes with various cations and anions, (b) a solvent or a mixture of solvents based on organic carbonates or other compounds, and (c) one or more additives. Any of (a), (b) and (c) may be selected from the claimed structures of the present invention.

2. Description of the Prior Art

Li ion chemistry is established upon reversible intercalation/de-intercalation of Li ion into/from host compounds. The voltage of such an electrochemical device is determined by the chemical natures of the anode and cathode, where Li ion is accommodated or released at low potentials in the former, and at high potentials in the latter. Apparently, the reversibility of the cell chemistry and the resultant energy density are limited by the stability of the electrolyte to withstand the reductive and oxidative potentials of these electrodes. In today's market, a majority of Li ion batteries use organic carbonate as electrolyte solvents, which decompose oxidatively above 4.5 V vs. Li, and set an upper limit to the candidate cathode chemistry. In spite of the fact that 5 V Li ion chemistry has already been made available from such cathodes like olivine structured LiCoPO₄ (˜5.1 V) and spinel structured LiNi_{0.5}Mn_{1.5}O₄ (˜4.7 V), their advantages such as high energy density and quality cannot be realized due to the lack of an electrolyte that is able to withstand high voltage operation.

Early attempts have been made to identify an electrolyte system that can resist oxidation beyond 5.0 V, and unsymmetrical sulfones were shown to be such a system on spinel LiMn₂O₄ surface (K. Xu, et al., J. Electrochem. Soc., 1998, Vol. 145, L70; J. Electrochem. Soc., 2002, Vol. 149, A920). However, intrinsic shortcomings of sulfone as a major electrolyte component, including its failure to form a protective layer on graphitic anode, slow Li ion kinetics, and poor electrode active material utilization caused by high viscosity, prevented wide application.

Additional improvements were also made on mitigating the oxidizing nature on the cathode surfaces through surface coating approaches, and various metal oxides or phosphates were shown to be effective in elongating the service life of the carbonate-based electrolytes (J. Liu, et al., Chem. Mater, 2009, Vol. 21, 1695). But these coating approaches have their own intrinsic shortcomings as well. They not only add additional cost to the manufacturing of the cathode materials, but also induce further interphasial resistance to the Li ion migration at electrolyte/cathode junction. Moreover, overall coverage of cathode particle surface with those inert coatings will inevitably decrease the energy density of the device.

It is therefore of significant interest to the battery industry to find a technology that can effectively enable the 5.0 V class cathode to be applied in Li ion batteries, without the aforementioned shortcomings.

To be more specific, it is therefore of significant interest to the battery industry to find a technology that can effectively enable the 5.0 V class cathode to be applied in Li ion batteries, while there is no major negative impacts on the original electrolyte and cathode materials. Such negative impacts have been exhibited in the prior art, and include but are not limited to, the failure of electrolyte to form desired interphasial chemistry on graphitic anode, the slowed Li ion kinetics and difficult electrode wetting due to high electrolyte viscosity, the increased electrolyte/cathode interphasial impedance, additional processing cost of material manufacturing, and sacrificed cathode energy density.

It is therefore still of significant interest to the battery industry to identify such electrolytes that can stably support reversible Li ion chemistry, without those shortcomings exhibited by the prior art.

It is therefore still of significant interest to the battery industry to identify such compounds that, once incorporated as an electrolyte component, can assist in forming a protective layer on the surface of the 5.0 V class cathodes.

It is therefore still of significant interest to the battery industry to identify such compounds that could serve the aforementioned purposes, either as electrolyte solvent, co-solvent, solute, or both molecular and ionic additives.

This invention will provide such a technology of the electrolytes with all those desired advantages.

### SUMMARY OF THE INVENTION

Therefore, it is highly desirable to develop electrochemical cells that can reversibly store and release electricity at voltages above 4.5 V.

More specifically, it is highly desirable to develop electrochemical cells that can reversibly store and release electricity at voltages in the neighborhood of or above 5.0 V.

Still more specifically, it is highly desirable to develop the aforementioned electrochemical cells, which include, but are not limited to, rechargeable batteries that are based on Li ion chemistry, or electrochemical double-layer capacitors that comprise high surface area electrodes.

Still more specifically, it is highly desirable to develop the aforementioned electrochemical cells based on Li ion chemistry, which comprise 5.0 V class cathode materials such as, but are not limited to, spinel metal oxide LiNi_{0.5}Mn_{1.5}O₄ or olivine phosphate LiCoPO₄ or LiNiPO₄.

Still more specifically, it is highly desirable to develop the aforementioned electrochemical cells based on electrochemical double layer capacitance, which comprise high surface area materials as electrodes, such as, but are not limited to, activated carbon, aligned or random carbon nanotubes, various aerogels and other materials having high surface area regardless of their chemical natures.

Further more specifically, it is highly desirable to formulate electrolyte compositions that would enable the aforementioned electrochemical cells.

Further more specifically, it is highly desirable to identify and develop compounds that, once incorporated into electrolytes either as solvent, co-solvent, solute or molecular and ionic additives, would assist in stabilizing the electrolyte against oxidative decompositions, without negatively impacting the properties and performances of the electrochemical cells as in the prior art.

It is therefore the primary object of the present invention to identify and develop such compounds.

It is another object of the present invention to develop the electrolyte compositions utilizing the said compounds either as solvent, co-solvent, solute, or molecular and ionic additives. Electrolytes so formulated will have an extra wide electrochemical stability window, and are capable of supporting electrochemical processes occurring at high potentials without degrading.

It is still another object of the present invention to assemble electrochemical cells utilizing the said electrolyte solutions. The said electrochemical cells include, but are not limited to, rechargeable batteries or electrochemical double-layer capacitors that have been described above. The cells thus developed should deliver superior performances as compared with the state-of-the-art technologies in terms of the energy density and energy quality.

These and additional objects of the invention are accomplished by adopting one or more compounds either as solvent, co-solvent, solute, or molecular and ionic additives in the non-aqueous electrolytes. More particularly, these objects are accomplished by adopting one or more compounds in the non-aqueous electrolytes, which are soluble in the non-aqueous, organic electrolyte solvents to certain concentrations. Still more particularly, these compounds, upon dissolution in the non-aqueous electrolytes, will form desirable interphasial chemistry on cathode surfaces.

Still more particularly, these compounds, upon dissolution in the non-aqueous electrolytes, will either form desirable interphasial chemistry on anode surfaces, or will not negatively impact the other electrolyte components to form desirable interphasial chemistry on anode surfaces.

With the electrolyte solutions comprising these compounds either as solvent, co-solvent, solute, or molecular and ionic additives in the non-aqueous electrolytes, all the said objects can be achieved.

### DEFINITIONS

Before describing the present invention in detail, it may be helpful to define the terminologies used in this invention to understand the scope of this invention. It is to be understood that the definitions herein are for the purpose of describing particular embodiments only, and are not intended to be limiting.

“Organic” refers to a structure that contains hydrocarbon moieties.

“Inorganic” refers to a structure that contains no hydrocarbon moieties.

“Halogen” refers to fluorine, chlorine, bromine and iodine.

“Alkyl” refers to a hydrocarbon structure, with or without unsaturations, or their perhalogenated or partially halogenated derivatives.

“Solvent” refers to molecular components of the electrolyte.

“Solute” or “salt” refers to ionic components of the electrolyte, which will dissociate into cationic and anionic species upon dissolution in the solvents or mixture of co-solvents.

“Co-solvents” refers to molecular components of the electrolyte whose concentrations are at least 10% by weight.

Furthermore, “additives” are the molecular components of the electrolyte, whose concentrations are lower than 10% by weight.

“Molecular” refers to compounds that cannot be dissociated into any ionic species in non-aqueous electrolyte solvents.

“Ionic” refers to compounds that can be dissociated into a cation species that bears positive charge and an anion species that bears equal but negative charge in non-aqueous electrolyte solvents.

### BRIEF DESCRIPTION OF THE DRAWINGS

A more complete appreciation of the invention will be readily obtained by reference to the following Detailed Description of the Preferred Embodiments and the accompanying drawings. The representations in each of the following figures and examples are intended to demonstrate the spirit of the present invention by way of illustration. They are by no means intended to limit the full extent of the invention; but rather, the present invention may be employed according to the full scope and spirit of the invention as defined in the appended claims.

FIGS. 1A and 1B show the comparison of voltage profiles between baseline, state of the art electrolyte (FIG. 1A) and 1% additive of Tris(1,1,1,3,3,3-hexafluoro-iso-propyl)phosphate (HFiP) in base electrolyte on LiNi_{0.5}Mn_{1.5}O₄ surface (FIG. 1B). FIG. 1A shows the standard electrolyte fading in capacity from the first cycle (furthest right curve) to the 80^{th} cycle (furthest left curve). For graphic clarity, only cycles between the initial and the 80^{th} were shown with an increment of 10 cycles. In FIG. 1B, the presence of 1% HFiP in the electrolyte suppresses the loss in capacity during cycling so that the 80^{th} cycle nearly overlaps with the first cycle.

FIG. 2 is a graphical representation of the capacity of cells using a 1% HFiP additive. This is a different way of looking at FIGS. 1A and 1B, where the materials and conditions are the same. In FIG. 2, the results for the standard electrolyte is shown in the lower curve and clearly slopes downward with increasing large losses in capacity as cycle number increases. The HFiP-containing electrolyte shows no capacity fade (upper curve) and has a low linear rate of capacity loss over the duration of the test.

FIG. 3 shows the results when a 1% HFiP-containing electrolyte is used in a “full” lithium ion cell. Full cells refer to those having a cathode and an intercalation anode such as graphite. In this figure, the system used is the standard LiNi_{0.5}Mn_{1.5}O₄ cathode and a graphite anode and the electrolytes are standard and standard +1% HFiP. The lower curve shows the performance of the standard electrolyte, which initially has higher capacity than the HFiP-containing electrolyte but rapidly fades. The HFiP-containing electrolyte again shows a much more controlled rate of capacity loss which is steady and always less than that of the state of the art electrolyte cell.

FIG. 4 shows the performance of a LiNi_{0.33}Mn_{0.33}Co_{0.33}O₂ cathode half cell (vs Li metal) using a state of the art electrolyte (lower curve) and the electrolyte +0.3% HFiP (upper curve). The voltage cutoff was 4.5V, lower than the 4.95V cutoff of the LiNi_{0.33}Mn_{0.33}Co_{0.33}O₂ cathode material. Capacity utilization of the cathode was much greater in the cell with HFiP in the electrolyte and its resistance to fade and failure was markedly better than the cell using the standard electrolyte.

FIG. 5 shows the performance of 0.3% HFiP in a half cell (vs Li metal) configuration. against a LiNi_{0.5}Mn_{1.5}O₄ cathode with a cutoff voltage of 4.5V.

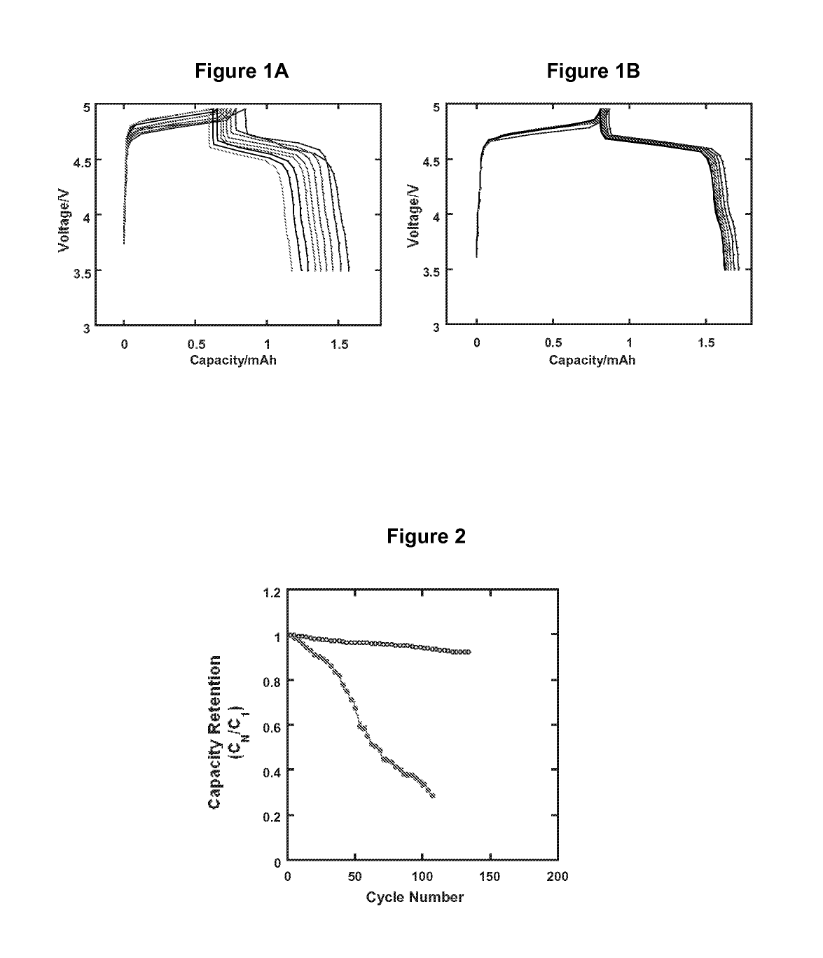

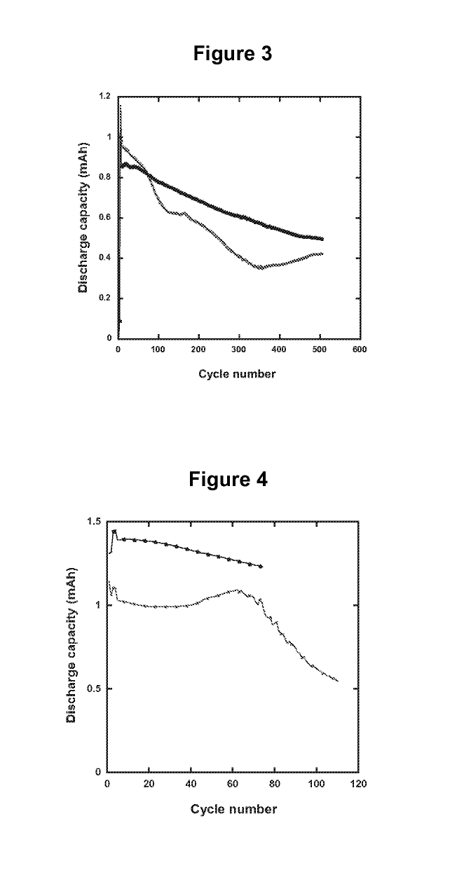

### DETAILED DESCRIPTION OF THE PREFERRED EMBODIMENTS

As a primary aspect of the invention, the compounds of the present invention are constructed on the basis of the molecular or ionic compounds whose skeleton structures were shown in structures 1 through 8 in Table 1, below, where R¹, R², R³, R⁴, R⁵ and R⁶ designate a substituent, which can be identical or different from each other. These are hydrogen, hydroxyl, or halogen which includes at least one F atom. The hydroxyl is hydroxide salts with metal ions of various valences, examples of which include, but are not limited to, Li⁺, Na⁺, ½Mg²⁺, ⅓Al³⁺. R¹-R⁶ are normal or branched alkyls with a carbon number from 1 through 30, with or without unsaturation. These are halogenated normal or branched alkyls with a carbon number from 1 through 30, with or without unsaturation which can be partially halogenated or perhalogenated, normal or branched alkyls with a carbon number from 1 through 30, with or without unsaturation; which can be partially halogenated or perhalogenated normal or branched alkyls with carbon number from 1 through 30, where the halogen substituents can be identical or different selected from F, Cl, Br or I, or mixture of all halogens.

TABLE 1
Structure of Compounds in the Present Invention

| | |
|---|---|
| 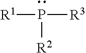 | (1) |
| 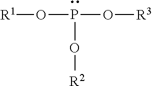 | (2) |
| 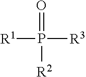 | (3) |
| 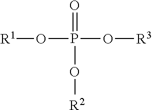 | (4) |
| 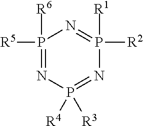 | (5) |
| 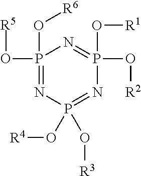 | (6) |
| 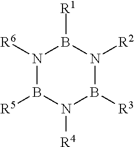 | (7) |
| 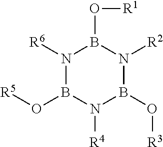 | (8) |

Examples of R¹, R², R³, R⁴, R⁵ and R⁶ include, but are not limited to, trifluoro-methyl, trichloromethyl, 1,1,1-trifluoroethyl, perfluoroethyl, perfluoro-iso-propyl, 1,1,1,3,3,3,-hexafluoropropyl, perfluoro-tert-butyl, and perfluorododecayl. As a way to illustrate, Table 2 lists selected compounds included in the compound families as described in Table 1.

TABLE 2
Example of Compounds covered in Table 1

| | |
|---|---|
| 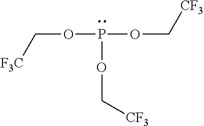 | (9) |
| 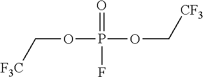 | (10) |
| 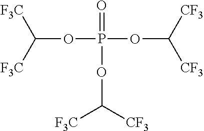 | (11) |
| 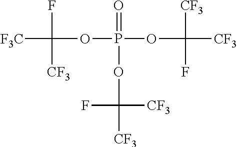 | (12) |
| 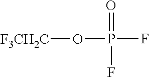 | (13) |
| 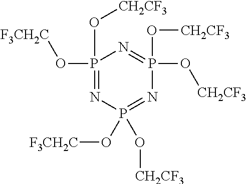 | (14) |
| 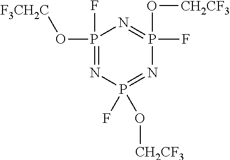 | (15) |
| 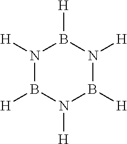 | (16) |
| 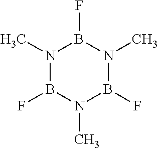 | (17) |

Preferentially, but not intended to be limiting, the compounds can be dissolved in a typical non-aqueous electrolyte solvent or mixture of solvents.

Preferentially but not intended to be limiting, the compounds can serve in the electrolyte either as major solvents, or co-solvents at concentrations above 10% by weight, or as salts at concentrations as high as 3.0 m, or as additives at concentrations below 10% by weight.

The above-mentioned typical non-aqueous electrolyte solvents comprise, but are not limited to, organic carbonate esters such as ethylene carbonate (EC), propylene carbonate (PC), dimethylcarbonate (DMC), ethylmethylcarbonate (EMC), diethylcarbonate (DEC), 1-(trifluoromethyl)ethylene carbonate (CF₃-EC); or organic acid esters such as alkyl carboxylates or lactones; and inorganic acid esters such as alkyl sulfonates, alkyl sulfurates, alkyl phosphonates or alkyl nitrates; or dialkyl ethers that are either symmetrical or unsymmetrical, or alkyl nitriles.

The above-mentioned typical non-aqueous electrolytes also comprise electrolyte solutes that are based on a cation and an anion. The cation selections include but are not limited to, alkali metal salts such as lithium (Li), sodium (Na), potassium (K) or alkali earth metal salts such as beryllium (Be), magnesium (Mg), calcium Ca), or tetraalkylammonium or phosphate (R₄N, R₄P); whereas the anion selections include but are not limited to hexafluorophosphonium (PF₆), hexafluoroarsenate (AsF₆), tetrafluoroborate (BF₄), perfluoroalkylfluorophosphate (PFₓR_{F(6-x)}), perfluoroalkylfluoroborate (BFₓR_{F(4-x)}), bis(trifluoromethanesulfonyl)imide ((CF₃SO₂)₂N), bis(perfluoroethanesulfonyl)imide ((CF₃CF₂SO₂)₂N), bis(oxalato)borate ((C₂O₄)₂B), (difluorooxalato)borate (C₂O₄FB).

Either the cation or the anion, or both the cation and the anion can be derived from the structures disclosed in Tables 1 and 2. The salts are selected by combining these cations and anions. Other derivatives with different compound structures may be used in this invention within the ordinary skill of the art.

More preferentially but not intended to be limiting, the compounds of this invention comprise at least one fluorine atom in the structure.

With the purpose of illustrating only and no intention to be limiting, compounds of this invention can be selected from the following list: tris(1,1,1,3,3,3-hexafluoro-iso-propyl)phosphate (compound 11 in Table 2), tris(perfluoroethyl)phosphate, tris(perfluoro-iso-propyl)phosphate (compound 12 in Table 2), bis(1,1,1-trifluoroethyl)fluorophosphate (compound 10 in Table 2), tris(1,1,1-trifluoroethyl)phosphite (compound 9 in Table 2); hexakis(1,1,1-trifluoroethoxy)phosphazene (compound 14 in Table 2), and tris(1,1,1-trifluoroethoxy)trifluorophosphazene (compound 15 in Table 2), hexakis(perfluoro-t-butyl)phosphazene and tris(perfluoro-t-butyl)phosphate.

In yet further aspects of the invention, electrochemical devices that are filled with the electrolyte solution formulated in this invention are fabricated. These devices include, but are not limited to, (1) lithium batteries with lithium metal cells as anode, and various transition metal oxides, phosphates and fluorides as cathode; (2) Li ion batteries with carbonaceous such as graphitic, carbon nanotube, graphene as anode, or non-carbonaceous such as titania or other Li⁺ intercalating hosts as anode, and various transition metal oxides, phosphates and fluorides as cathode; (3) electrochemical double-layer capacitors with both carbonaceous and non-carbonaceous electrodes of high surface area or high pseudo-capacitance; and (4) dual intercalation cells in which both cation and anion intercalate simultaneously into lattices of anode and cathode materials of either carbonaceous or non-carbonaceous natures, respectively.

The above cells are assembled according to the procedures that can be readily performed by one with ordinary skill in the art. These electrochemical devices containing the electrolyte solutions as disclosed in the present invention can enable high voltage rechargeable chemistries that would be otherwise impossible with the state-of-the-art electrolyte technologies.

Having described the invention, the following examples are given to illustrate specific applications of the invention including the best mode now known to perform the invention. They are intended to provide those of ordinary skill in the art with a complete disclosure and description of how to make and use the solvents and additives of this invention. These specific examples are not intended to limit the scope of the invention described in this application.

### EXAMPLES

### Example 1

### Synthesis of Tris(1,1,1,3,3,3-hexafluoro-iso-propyl)phosphate (compound II in Table 2)

To a flask containing 500 mL of diethyl ether, 175 g of 1,1,1,3,3,3-hexafluoro-isopropanol is added and stirred until a complete solution is made. To the stirred solution of diethyl ether and 1,1,1,3,3,3-hexafluoropropanol, 8.28 g of solid lithium hydride is added through a solid-addition funnel and allowed to react at room temperature. After 1 hour, the reaction mixture is chilled to the range of 0-5° C. by immersion in a water/ice bath. Once chilled, 53.21 g of phosphorus oxychloride is carefully added. The reaction is considered complete once no more insoluble lithium chloride is formed during reflux of the reaction mixture. The final product, tris(1,1,1,3,3,3-hexafluoroisopropyl)phosphate, is recovered by distillation after filtering off the precipitation.

### Example 2

### Synthesis of Tris(perfluoro-iso-propyl)phosphate (compound 12 in Table 2)

The synthesis of precursor tris(iso-propyl)phosphate was conducted in a similar manner as described in Example 1. The intermediate phosphate was then subjected to either elemental fluorination or electrochemical fluorination to achieve the perfluorinated product. The final product, tris(perfluoro-iso-propyl)phosphate, is recovered by distillation after purification.

### Example 3

### Synthesis of Tris(1,1,1-trifluoroethyl)phosphate

The synthesis of 1,1,1-trifluoroethoxide lithium was similar to the procedure as described in Example 1. 53.21 g of phosphorus oxychloride is carefully added to a flask containing 500 mL of diethyl ether. The reaction is considered complete after refluxing. The final product, tris(1,1,1-trifluoroethyl)phosphate, is recovered by distillation after filtering off the precipitation.

### Example 4

### Synthesis of Hexakis(1,1,1-trifluoroethoxy)phosphazene (compound 14 in Table 2)

To a flask containing 500 mL of diethyl ether, 69.1 g of 1,1,1-trifluoroethanol is added and stirred until a complete solution is made. Then 5.48 g lithium hydride was gradually added through a solid addition funnel. After 1 hour, the reaction mixture is chilled to the range of 0-5° C. by immersion in a water/ice bath. Once chilled, 40 g of phosphonitrillic chloride trimer was carefully added with vehement stirring. The purification process was similar to what described in Example 1. After repeated distillation, the final product is a colorless liquid with boiling point of 100° C. at 0.1 torr.

### Example 5

### Formulation of Electrolyte Solutions

This example summarizes a general procedure for the preparation of electrolyte solutions comprising the solvents, solutes and additives of this invention, whose structures have been listed in Table 1. Both the concentration of the lithium salts, the co-solvent ratios, and the relative ratios between the additives to solvents can be varied according to needs.

The salts selected include, but are not limited to, LiPF₆, LiAsF₆, LiBF₄, LiP(CₙF₂ₙ₊₁)ₓF₆₋ₓ (0≦n≦10, 0≦x≦6), LiB(CₙF₂ₙ₊₁)ₓF₄₋ₓ (0≦n≦10, 0≦x≦4), LiIm, LiBeti, LiBOB, and LiBF₂C₂O₄, triethylmethylammonium (Et₃MeNPF₆), any one or more of the compounds whose structures are listed in Table 1, and mixtures thereof.

The solvents selected include, but are not limited to, EC, PC, DMC, DEC, EMC, FEC (fluoro ethylene carbonate), CF₃-EC, any one or more of the compounds whose structures are listed in Table 1, and mixtures thereof.

The additives selected include any one or more of the compounds whose structures are listed in Table 1 or Table 2, and mixtures thereof.

The resultant electrolyte solution should contain at least one of those compounds that are disclosed in the present invention.

In one instance, 1000 g base electrolyte solution of 1.0 m LiPF₆/EC/EMC (30:70) was made in glovebox by mixing 300 g EC and 700 g EMC, followed by adding 151.9 g LiPF₆. The aliquots of the base electrolyte solution was then taken to be mixed with various amounts of tris(1,1,1,3,3,3-hexafluoro-iso-propyl)phosphate as synthesized in Example 1. The concentration of tris(1,1,1,3,3,3-hexafluoroisopropyl)phosphate ranges from 0.1 ppm to 5%.

In a similar instance, 1000 g base electrolyte solution of 1.0 m LiPF₆/FEC/EC/EMC (15:15:70) was made in glovebox by mixing 150 g FEC, 150 g EC and 700 g EMC followed by adding 151.9 g LiPF₆, and aliquots of the base electrolyte solution was then taken to be mixed with various amount of tris(1,1,1,3,3,3-hexafluoroisopropyl)phosphate as synthesized in Example 1. The concentration of tris(1,1,1,3,3,3-hexafluoroisopropyl)phosphate ranges from 0.1 ppm to 5%.

In another similar instance, 1000 g base electrolyte solution of 1.0 m LiPF₆/tris(1,1,1,3,3,3-hexafluoroisopropyl)phosphate/EC/EMC (15:15:70) was made in glovebox by mixing 150 g tris(1,1,1,3,3,3-hexafluoroisopropyl)phosphate as synthesized in Example 1, 150 g EC and 700 g EMC, followed by adding 151.9 g LiPF₆.

In other similar instances, the electrolyte solutions with other compounds at varying concentrations were also made with tris(perfluoro-iso-propyl)phosphate (compound 12 in Table 2), or hexakis(1,1,1-trifluoroethoxy)phosphazene (compound 14 in Table 2), or tris(1,1,1-trifluoroethyl)phosphate.

With purpose of illustrating only and no intention to be limiting, Table 3 lists some typical electrolyte solutions prepared and tested. It should be noted that the compositions disclosed in Table 3 may or may not be the optimum compositions for the electrochemical devices in which they are intended to be used, and they are not intended to limit the scope of the present invention.

TABLE 3
Electrolyte Solutions with Additives

| Salt | | Additive |
|---|---|---|
| Concentration | Solvent Ratio | Concentration |
| (m) | (by Weight) | (by Weight) |
| LiPF₆ (1.0) | EC/FEC/EMC | 1% Compound 9 |
| | (15:15:70) | |
| LiPF₆ (1.0) | EC/tris(1,1,1-trifluoro- | 1% Compound 11 |
| | ethyl)phosphate/EMC | |
| | (20:10:70) | |
| LiPF₆ (1.0) | EC/EMC (30:70) | 1% Compound 14 |
| LiPF₆ (1.0) | EC/EMC (30:70) | 1% Compound 9 |
| LiBF₄ (1.0) | EC/EMC (30:70) | 1% Compound 11 |
| LiBOB (1.0) | EC/γBL/EMC/MB | 1% Compound 9 |
| | (15:15:30:30) | |
| Et₃MeNPF₆ (2.0) | EC/EMC (30:70) | 1% Compound 16 |

### Example 6

### Fabrication of an Electrochemical Cell

This example summarizes the general procedure of the assembly of electrochemical cell. These electrochemical cells include Li ion cell, double layer capacitor, or dual intercalation cell. Typically, a piece of Celgard polypropylene separator was sandwiched between an anode and a cathode. The cell was then activated by soaking the separator with the electrolyte solutions as prepared in Example 5, and sealed with appropriate means. All the above procedures were conducted under dry atmospheres in either glovebox or dryroom.

The electrolyte co-solvents or additives of this invention will perform most effectively in electrolyte solutions that are widely adopted by the industry of Li ion batteries. The electrolytes comprise of one or more lithium salts dissolved in neat or mixture of organic or inorganic esters, ethers, nitriles, sulfones or anhydrate, where the lithium salts are based on various fluorinated or non-fluorinated anions, the examples of which include but are not limited to, hexafluorophosphate, bis(trifluoromethanesulfonyl)imide, bis(oxalato)borate, fluorooxalatoborate, and tetrafluoroborate. The organic or inorganic solvents include but are not limited to ethylene carbonate, dimethylcarbonate, ethylmethylcarbonate, propylene carbonate or ethylmethyl sulfone. A typical baseline electrolyte solution pertaining to the above description is 1.2 M lithium hexafluorophosphate dissolved in a mixture of ethylene carbonate and dimethylcarbonate by 30:70 volume ratio. The concentration of co-solvent or additive should be adjusted to its optimum value in the above electrolyte solution to yield the most effective performance. The amount of additive to be used is scaled with the surface area of the cathode material. A typical electrolyte formulation is 5 mM additive mixed in the baseline electrolyte. For high surface area cathode materials, up to 20 mM additives can be used.

The electrolyte co-solvents and additives are expected to perform more effectively on those cathode materials whose reversible lithiation/de-lithiation potentials occur above 4.2 V vs. Li. The cathode materials include but are not limited to spinel metal oxides or olivine metal phosphates with varying ratio of metals selected from transition groups of the periodic table, examples of which include, but are not limited to, LiMn_{1.5}Ni_{0.5}O₄, LiCoPO₄, LiNiPO₄ and doped derivatives thereof. See for example the spinel oxide cathodes disclosed in K. Amine, et al., J. Power Source., 1997, Vol. 68, 604-608, U.S. Pat. No. 7,718,319 and U.S. Published Application 20100183925 in the names of Arumugam Manthiram et al., the disclosures of which are hereby incorporated by reference.

The test cells are to be assembled in either cathode half cell configurations with lithium metal as anode, or Li ion full cell configurations with either graphitic carbon or other intercalation materials such lithiated titanate as an anode. For the best performance, these cathode materials should be coated on Al foil, and should be placed on Al-clad cells parts when assembled into a cell. However, stainless steel should not be used as current collector at the cathode side. As an example, a typical coin cell is constructed by using the following coin cell parts:
1. Case: SUS304 Ni-plated with aluminum cladding (cathode current collector);
2. Cap: SUS316L stainless steel (anode current collector);
3. Gasket: Polypropylene;
4. Spacer disc: SUS316L stainless steel 15.5 mm diam.×0.5 mm thick (in contact with anode); and
5. Wave spring: SUS316L stainless steel 15 mm diam.×1.4 mm high (in contact with anode).

Celgard 2400 polypropylene with no surfactant coating is generally used as a separator. Amount of electrolyte added is <50 μL, and use of electrolyte is kept to the absolute minimum necessary to wet the separator sheets and provide continuous contact between electrodes. Effort should be made to avoid any wetting of unnecessary cell parts. Finally, for the purpose of demonstration and in no manner to be limiting, using the electrodes, electrolytes and cell parts as described above, the best cell performance is expected if the cell is formed in a series of “forming cycles”, where the cells are gradually brought to certain low voltage stages before being exposed to 5.0 V. As an example, a typical protocol for the forming of the cathode half cell based on LiNi_{0.5}Mn_{1.5}O₄ spinel material from Argonne National Laboratory is as follows using constant current:

Forming step 1: 3.5V-4.2V, C/10 rate, two cycles;

Forming step 2: 3.5V-4.5V, C/10 rate, two cycles; and

Forming step 3: 3.5V-4.95V, C/5 rate, two cycles.

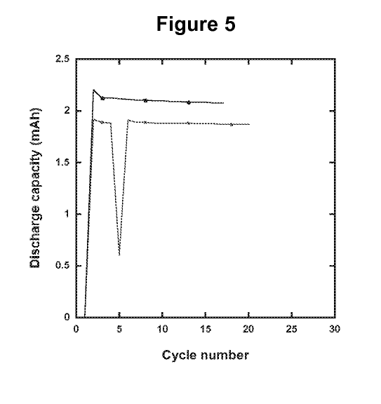

FIG. 5 demonstrates the effectiveness of one of the additives disclosed in this invention, HFiP, on different cathode materials, which include the high voltage (4.6 V) spinel LiNi_{0.5}Mn_{1.5}O₄, its derivatives and low voltage (4.2 V) layer oxide compounds based on LiNi_{0.80}Co_{0.15}Al_{0.05}O₂ and LiNi_{1/3}Mn_{1/3}Co_{1/3}O₂, respectively. In this test, the state of the art electrolyte (lower curve) shows a lower capacity utilization of the cathode material as compared to a similar cell that had 0.3% HFiP in the state of the art electrolyte. In all cases, electrolytes with 5 mM of HFiP showed higher capacity utilization, slower fading rate and higher stability.

With the invention having been described in general and in details and the reference to specific embodiments thereof, it will be apparent to one ordinarily skilled in the art that various changes, alterations, and modifications can be made without departing from the spirit and scope of the invention and its equivalents as defined by the appended claims.

What is claimed:

1. A non-aqueous electrolyte solution for a high energy electrochemical cell containing at least one compound to passivate the oxidizing surface of a cathode in said electrochemical cell, said compound selected from the group comprising: 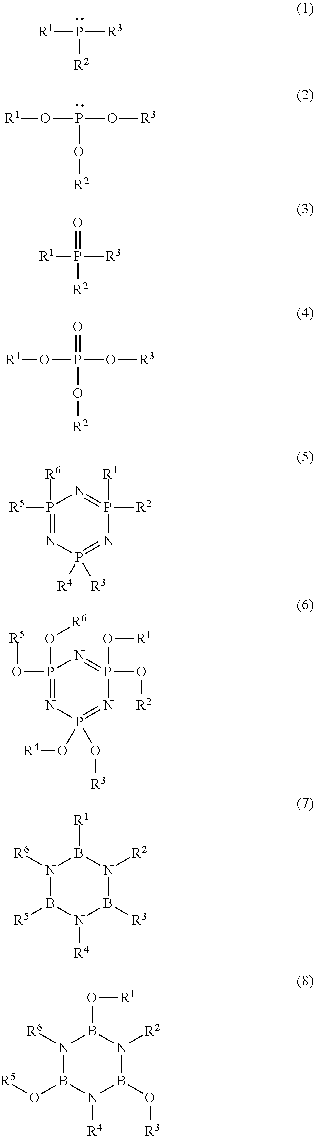
where:
R¹, R², R³, R⁴, R⁵ and R⁶ designate substituents,
which are identical or different from each other;
which are hydrogen, hydroxyl, or halogen containing at least one F atom;
which are hydroxide salts with metal ions of various valences, comprising Li⁺, Na⁺, ½Mg²⁺or ⅓Al³⁺;
which are normal or branched alkyls with a carbon number from 1 through 30, with or without unsaturation;
which are halogenated normal or branched alkyls with a carbon number from 1 through 30, with or without unsaturation;
which are partially halogenated or perhalogenated normal or branched alkyls with a carbon number from 1 through 30, with or without unsaturation; or
which are partially halogenated or perhalogenated normal or branched alkyls with a carbon number from 1 through 30, where the halogen substituents are identical or different and selected from the group of F, Cl, Br or I, or mixtures thereof.

2. The electrolyte solution of claim 1 containing at least one compound selected from the group comprising tris(1,1,1,3,3,3-hexafluoro-iso-propyl)phosphate, tris(perfluoroethyl)phosphate, tris(perfluoro-iso-propyl)phosphate, bis(1,1,1-trifluoroethyl)fluorophosphate, tris(1,1,1-trifluoroethyl)phosphate, hexakis(1,1,1-trifluoroethoxy)phosphazene, tris(1,1,1-trifluoroethoxy)trifluorophosphazene, hexakis(perfluoro-t-butyl)phosphazene and tris(perfluoro-t-butyl)phosphate.

3. The electrolyte solution of claim 2, wherein the compound is tris(1,1,1,3,3,3-hexafluoro-iso-propyl)phosphate.

4. The electrolyte solution of claim 2, wherein the compound is tris(perfluoro-t-butyl)phosphate.

5. The electrolyte solution of claim 2, wherein the concentration of the selected compound or mixtures thereof ranges from 0.1 ppm to 5% with respect to the total solvent weight.

6. The electrolyte solution of claim 3, wherein the concentration of tris(1,1,1,3,3,3-hexafluoro-iso-propyl)phosphate is 1% with respect to the total solvent weight.

7. The electrolyte solution of claim 3, wherein the concentration of tris(1,1,1,3,3,3-hexafluoro-iso-propyl)phosphate is 0.3% with respect to the total solvent weight.

8. The electrolyte solution of claim 2 containing a solvent selected from the group comprising cyclic or acyclic carbonates, carboxylic esters comprising ethylene carbonate (EC), propylene carbonate (PC), vinylene carbonate (VC), dimethyl carbonate (DMC), diethyl carbonate (DEC), ethylmethyl carbonate (EMC), fluoro ethylene carbonate (FEC), γ-butyrolactone, methyl butyrate, ethyl butyrate; cyclic or acyclic ethers comprising diethylether, dimethyl ethoxglycol, tetrahydrofuran; cyclic or acyclic organic sulfones and sulfites comprising tetramethylene sulfone, ethylene sulfite, ethylmethyl sulfone, cyclic or acyclic nitriles comprising acetonitrile, ethoxypropionitrile and mixtures thereof.

9. The electrolyte solution of claim 2, which comprises a salt selected from the group comprising lithium hexafluorophosphate (LiPF₆), lithium hexafluoroarsenate (LiAsF₆), lithium tetrafluoroborate (LiBF₄), lithium perfluoroalkylfluorophosphate (LiP(CₙF₂ₙ₊₁)ₓF₆₋ₓ, where 0≦n≦10, 0≦x≦6), lithium perfluoroalkylfluoroborate (LiB(CₙF₂ₙ₊₁)ₓF₄₋ₓ, where 0≦n≦10, 0≦x≦4), lithium bis(trifluoromethanesulfonyl)imide (LiIm), lithium bis(perfluoroethanesulfonyl)imide (LiBeti), lithium bis(oxalato)borate (LiBOB), lithium (difluorooxalato)borate (LiBF₂C₂O₄) and mixtures thereof.

10. The electrolyte solution of claim 2, comprising ionic compound species to effectively passivate the cathode surface so that bulk electrolyte species or anions of the ionic additive remain stable on cathode surface up to potentials 5.0 V above that of Li, said species being either cation or anion or both and derived from any of the compounds in claim 2.

11. A high energy electrochemical cell comprising:
a negative electrode;
a positive electrode;
a porous polyolefin separator; and
an electrolyte solution containing at least one compound selected from the group comprising tris(1,1,1,3,3,3-hexafluoro-iso-propyl)phosphate, tris(perfluoroethyl) phosphate, tris(perfluoro-iso-propyl)phosphate, bis(1,1,1-trifluoroethyl)fluorophosphate, tris(1,1,1-trifluoroethyl)phosphate, hexakis(1,1,1-trifluoroethoxy)phosphazene, tris(1,1,1-trifluoroethoxy)trifluorophosphazene, hexakis(perfluoro-t-butyl)phosphazene and tris(perfluoro-t-butyl)phosphate;
wherein the negative electrode is selected from the group comprising carbonaceous materials with various degrees of graphitization, lithium or other alkaline metals, alloys of lithium or other alkaline metals or intercalation hosts of graphite, carbonaceous or oxides and non-intercalation hosts of high surface area and high pseudo-capacitance.

12. The electrochemical cell of claim 11, wherein the selected compound is tris(1,1,1,3,3,3-hexafluoro-iso-propyl)phosphate.

13. The electrochemical cell of claim 11, wherein the positive electrode comprises an active material selected from the group of transition metal oxides, metalphosphates, chalcogenides, and carbonaceous materials with various degrees of graphitization.

14. The electrochemical cell of claim 13, wherein the positive electrode is olivine structured LiCoPO₄, LiNiPO₄, spinel structured LiNi_{0.5}Mn_{1.5}O₄ or doped derivatives thereof.

15. The electrochemical cell of claim 11, comprising positive and negative electrodes of material having either high surface area for double-layer capacitance, or high pseudo-capacitance, or a mixture of both.

16. The electrochemical cell of claim 11, wherein the electrodes are activated carbon, aligned or random carbon nanotubes, aerogels and other material having a high surface area.

17. The electrochemical cell of claim 11, comprising a rechargeable lithium battery, a dual intercalation cell wherein both cation and anion intercalate simultaneously, a double-layer capacitor having high surface area electrodes or a pseudo capacitor.

18. A method to passivate the surface of an electrode in a high energy electrochemical cell comprising the steps of:
adding to the electrolyte solution at least one compound selected from the group comprising tris(1,1,1,3,3,3-hexafluoro-iso-propyl)phosphate, tris(perfluoroethyl)phosphate, tris(perfluoro-iso-propyl)phosphate, bis(1,1,1-trifluoroethyl)fluorophosphate, tris(1,1,1-trifluoroethyl)phosphate, hexakis(1,1,1-trifluoroethoxy)phosphazene, tris(1,1,1-trifluoro-ethoxy)trifluorophosphazene, hexakis(perfluoro-t-butyl)phosphazene, tris(perfluoro-t-butyl)phosphate, hexakis(perfluoro-t-butyl)phosphazene and tris(perfluoro-t-butyl)phosphate; and
forming a passivating layer on the electrode in the electrochemical cell upon initial charging of the electrode.

19. The method of claim 18, wherein the electrochemical cell is a rechargeable lithium battery.

20. The method of claim 18, wherein the electrode is a cathode.
